(19) United States
(12) Patent Application Publication
(10) Pub. No.: US 2026/0267028 A1
(43) Pub. Date: Sep. 10, 2026

(54) DETECTION METHOD FOR DETECTING ALARM OBJECTS IN PIECES OF LUGGAGE

(71) Applicant: SMITHS DETECTION GERMANY GMBH, Wiesbaden (DE)

(72) Inventor: Jens-Peter SCHLOMKA, Hamburg (DE)

(21) Appl. No.: 19/163,669

(22) PCT Filed: Mar. 12, 2024
(86) PCT No.: PCT/IB2024/052389

§ 371 Date: Apr. 8, 2026

(30) Foreign Application Priority Data
Mar. 10, 2023 (DE) 10 2023 202 195.1

(51) Int. Cl. G01V 5/22

(52) U.S. Cl. CPC G01V 5/22

(57) ABSTRACT

Described herein is a detection method for detecting alarm objects (AO) in items of baggage (B), the method including:
performing a transmission analysis (TA) on an item of baggage (B), generating a transmission result (TR),
segmenting the transmission result (TR) to identify objects (O),
generating a simulated simulation detector signal (SDS) for at least one identified object (O), assigning an alarm material (AM) using a diffraction simulation (DS),
performing a diffraction analysis (DA) on the item of baggage (B), generating a measurement detector signal (MDS),
reconstructing a measurement diffraction result (MDR) from the generated measurement detector signal (MDS),
reconstructing a simulation diffraction result (SDR) with the same dimensionality as the measurement diffraction result (MDR) based on the generated simulation detector signal (SDS),
comparing the measurement diffraction result (MDR) with the simulation diffraction result (SDR), and
outputting a comparison result (CR).

### CROSS-REFERENCE TO RELATED APPLICATIONS

The present application is a U.S. National Stage Application of International Patent Application No. PCT/IB 2024/052389, filed Mar. 12, 2024, which claims the benefit of priority to German Patent Application No. 102023202195.1, filed Mar. 10, 2023.

### FIELD OF THE DISCLOSURE

The present invention relates to a detection method for detecting alarm objects in items of baggage and a computer program product comprising commands for carrying out such a detection method.

### BACKGROUND

It is known that baggage monitoring needs to be carried out in security-sensitive areas, for example at airports. At airports, this applies in particular to so-called checked baggage, i.e. items of baggage which are to be transported in the cargo hold of an aircraft. In known solutions, the item of baggage is usually subjected to a transmission analysis. Such a transmission analysis is, for example, an X-ray computed tomography method. The result of such a transmission method can be described as a three-dimensional transmission result and serves to distinguish between different objects within the item of baggage and to detect, at least partially, the degree of risk they present. In the case of known security systems, a decision is made, on the basis of the transmission analysis and the evaluation of the three-dimensional transmission result, as to whether or not an alarm object may possibly be contained in the item of baggage. This may also be understood to be the output of an alarm signal.

To ensure that not every item of baggage in which a possible alarm object has been found actually also has to be actually opened and checked manually, many airports use a second, downstream detection method. This usually involves an optical checking of the transmission result by a person or possibly an algorithm. In some cases, a diffraction analysis, which is carried out using an X-ray diffraction device, is also performed. Every item of baggage that has triggered an alarm is fed to such a diffraction analysis. Here, an analysis of the item of baggage is carried out by means of X-rays in that X-rays diffracted within the item of baggage are captured by a corresponding detector and output as a detector signal. The detector signal itself is only of limited significance and is used to reconstruct a diffraction result on the basis of this detector signal. This reconstruction is usually achieved by converting the detector signal from the detector coordinate system into the coordinate system of the item of baggage. In a final step, in known methods the diffraction result reconstructed in this way is compared with information from an alarm database in order to decide whether the material of the alarm object is an alarm material. In other words, in this way the alarm can either be confirmed or cancelled with regard to the material composition of the alarm object.

A disadvantage of the known solutions is that the alarm databases show the diffraction results, in particular in the form of pulse transmission functions, in an idealised way. When carrying out the diffraction analysis in real life, the detector signal is affected by a large number of environmental parameters, baggage parameters and device parameters of the diffraction device so that there can sometimes be considerable deviations between an idealised diffraction result from the alarm database on the one hand and the real measurement result as the diffraction result on the other. For example, this deviation can be caused by absorption of parts of the radiation so that the data contain photon noise. Another example is the mixing of signals from different materials. As a result, these differences lead to an increased number of false alarms, i.e. an actually unnecessary manual checking of the item of baggage.

### SUMMARY

It is the object of the present invention to remedy, at least in part, the disadvantages described above. In particular, the object of the present invention is to improve the measurement result in a cost-effective and simple manner and to avoid or at least reduce false alarms with a high degree of certainty.

The above object is achieved by a detection method and a computer program product as claimed. Further features and details of the invention are disclosed in the dependent claims, the description and the drawings. Naturally, features and details described in connection with the detection method according to the invention also apply in connection with the computer program product according to the invention, and vice versa, so that with regard to disclosure mutual reference is or can always be made to the individual aspects of the invention.

According to the invention, a detection method is used to detect alarm objects in items of baggage. For this purpose, the detection method comprises the following steps:
performing a transmission analysis on an item of baggage, generating a transmission result,
segmenting the transmission result in order to identify objects,
generating a simulated simulation detector signal for at least one identified object, assigning an alarm material by means of a diffraction simulation specific to a diffraction analysis,
performing a diffraction analysis on the same item of baggage, generating a measurement detector signal,
reconstructing a measurement diffraction result from the generated measurement detector signal for the at least one object,
reconstructing a simulation diffraction result with the same dimensionality as the measurement diffraction result on the basis of the generated simulation detector signal for the at least one object,
comparing the measurement diffraction result with the simulation diffraction result,
outputting a comparison result.

A detection method according to the invention builds on the known solutions in which a combination of two different detection devices is used. As in the prior art, this involves a combination of a transmission device for performing a transmission analysis and a diffraction device for performing a diffraction analysis. This combination is also known as a System of Systems (SoS) device.

As in known solutions, the detection method starts with the performance of a transmission analysis, for example with the help of a computed tomography device, to check all items of baggage in an airport's checked baggage. During this performance, a transmission result is generated for each item of baggage, in many cases this is an image of the density distribution. This for example three-dimensional transmission result is now segmented, as also already known, so that individual objects within the transmission result are recognised as such and distinguished from other objects. During this segmentation for object detection, individual volume components, so-called voxels, which together form a homogeneous volume can for example be combined and can therefore be assigned, with a high degree of probability, to a single specific object. As a result, one or more objects within this transmission result can be identified on the basis of this transmission result.

The idea according to the invention is based on the fact that a simulation is carried out at least on one identified object. This simulation is a diffraction simulation, i.e. a simulation to generate a simulation detector signal such as is to be expected when exactly this object is subjected to a real diffraction analysis in a second step. In other words, in this step the subsequent diffraction analysis is simulated and a simulation detector signal is generated through this simulation. This means that, for this object within the transmission result, at least one alarm material is assumed for the subsequent diffraction simulation. Thus, a projection into the future takes place, in the event that the object consists of the assumed alarm material or at least contains it. This projection results in a simulated detector signal such as could result if the diffraction analysis were performed in real life. The diffraction simulation thus simulates the actual analysis sequence of the diffraction analysis to be performed subsequently and thus makes a prediction based on at least one assumed alarm material.

After this simulation step according to the invention, or also at the same time as this, the diffraction analysis can now actually be performed on a diffraction device so that a measured measurement detector signal is generated. In the next two steps, as already explained in the introduction, a simulation diffraction result and a measurement diffraction result are generated from the respective detector signals, i.e. from the simulation detector signal as well as from the measurement detector signal, via reconstruction steps. The reconstruction can for example involve the aforementioned back-projection from the detector coordinate system into the coordinate system of the item of baggage. The simulation diffraction result and the measurement diffraction result preferably have the same dimensionality, i.e. they are for example both three-dimensional. Other dimensionalities, for example carrying out the method with 2 dimensions or even more than 3 dimensions, are also conceivable in principle.

The core idea of the invention is that, in the final comparison step, the measurement diffraction result no longer has to be compared with a standardised and, above all, idealised alarm database. Rather, a comparison is made with an individual simulation diffraction result specific to exactly that identified object with an assumed alarm material. In other words, in the comparison step, not only is the measurement diffraction result individual for the current detection situation, so is the comparative value in the form of the simulation diffraction result. Finally, the comparison result is output, in particular in a qualitative way, i.e. with a statement as to whether the object actually comprises the assumed and assigned alarm material or not.

As an advantage over the known methods, an idealised alarm database is thus no longer used to finally carry out the comparison to determine whether an alarm object is present or not. Rather, the comparative value is also generated specifically and individually for the detected detection situation itself. This generation is ensured by the simulation step explained above, which ensures that the diffraction simulation takes into account specific characteristics and individual falsifications in the diffraction analysis carried out, even if alarm materials are assumed. In other words, the comparative value is adapted, through the diffraction simulation, to the individual situation of the object so that it can predict in an improved way what an assumed alarm material might actually look like for this object in the form of a simulation detector signal.

As a result of the preferably identical reconstruction of the simulation diffraction result generated on this basis, the detection accuracy is significantly increased so that the number of false alarms can be reduced and the reliability in the detection of alarm materials can be significantly increased. This is also helped by the fact that the diffraction simulation can make predictions regarding the noise that the diffraction measurement will exhibit. This allows statistical deviations to be distinguished from systematic deviations, which will increase the detection performance.

It may be advantageous if, in a detection method according to the invention, a simulated simulation detector signal is additionally generated for adjacent regions in addition to the at least one identified object with an assigned material. Since interaction with adjacent regions around the object also causes an impairment of the expected measurement detector signal, this impairment can already be taken into account in the diffraction simulation. Thus, not only the object, but also adjacent volume sections, also referred to as neighbouring voxels, are relevant for the measurement detector signal and must therefore also be taken into account in this embodiment for the generation of the simulation detector signal. In this way, it thus becomes possible to enable improved accuracy in the simulation so that the accuracy for the subsequent comparison and the associated reliability in the detection of alarm materials can also be increased accordingly.

It may also be advantageous if, in a detection method according to the invention, a preliminary analysis is performed for at least one identified object, in particular with regard to at least one of the following parameters:
form of the at least one identified object,
density of the at least one identified object.

The above list is a non-exhaustive list. Of course, two or more parameters can also be taken into account in combination in such a preliminary analysis. These parameters are used to decide, in the preliminary analysis, whether the object could in principle be an alarm object or not. Therefore, such a preliminary analysis can also be referred to as a pre-alarm, which leads to this item of baggage being directed to the second checking stage in the form of the diffraction analysis. If an alarm object is ruled out with a high degree of probability in the preliminary analysis, this item of baggage can be classified as “safe” and can bypass the diffraction analysis. In addition, the preliminary analysis can provide an indication as to which potential alarm material could possibly be involved. If, for example, the form, density or other parameters indicate an explosive material as an alarm material, then, on the basis of this result of the preliminary analysis, the alarm material for the generation step in the diffraction simulation can be selected accordingly.

It can also bring advantages if, in a detection method according to the invention, the further analysis is carried out depending on the result of the preliminary analysis. In the simplest case, this pre-alarm can therefore decide in principle whether the item of baggage is to be passed on for diffraction analysis or not. However, it is also possible that a correspondingly adapted selection of the alarm material or a defined quantity of alarm materials takes place. The analysis setting of the diffraction device and/or the reconstruction mechanism can also be adjusted.

In addition, it may be advantageous if, in a detection method according to the invention, the diffraction simulation takes into account at least one of the following parameters:
angular resolution of the diffraction analysis to be performed,
spatial resolution of the diffraction analysis to be performed, which can lead to signal mixing,
attenuation of the scattering signal of the diffraction analysis to be performed by further objects in the item of baggage and thus the expected distribution of the variance of the (Poisson) noise over the momentum transfer axis (energy axis),
attenuation of the detector response during the diffraction analysis to be performed.

The above list is a non-exhaustive list. The parameters to be taken into account are in particular dependent on and selected for the diffraction device actually used. Such parameters can also be adjusted specifically for the respective item of baggage and/or the respective object in order to further increase accuracy for the result of the diffraction simulation and thus improve the quality of a detection method according to the invention.

It may further be advantageous if, in a detection method according to the invention, a back-projection or reconstruction is carried out in order to generate the measurement diffraction result and/or the simulation diffraction result. This back-projection for the reconstruction step is, as already explained, for example a back-projection from the coordinate system of the detector into the coordinate system of the item of baggage. In particular, identical back-projection algorithms can be used for both the simulation diffraction result and the measurement diffraction result. In particular, this is the case if a separate segmentation can be carried out for the measurement diffraction result to provide further identification of objects.

It may be advantageous if, in a detection method according to the invention, the step of segmenting the transmission result is carried out on the basis of homogeneous volumes. Of course, other segmentation options are also conceivable. However, the application of homogeneous volumes provides a simple and quick starting point for carrying out effective segmentation in order to identify objects. As has already been explained with reference to the preliminary analysis, an indication of the respective material for the selection of the alarm material in the simulation step can also be provided.

It also brings advantages if, in a detection method according to the invention, this is carried out for at least two different identified objects in the item of baggage. In particular, if not just a single object but several objects in an item of baggage have not only been detected, through segmentation, but also identified as potentially hazardous, the further steps of simulation, reconstruction and comparison can be advantageously carried out for all identified alarm objects. When executed in a computer program, this is in particular carried out in a sequential manner by the respective computer program so that all objects are checked step by step for the respective assigned alarm material. It may also be advantageous if, in a detection method according to the invention for the at least one identified object, at least two different alarm materials can be assigned for the generation of, accordingly, at least two different simulated simulation detector signals. Usually, not only a single alarm material is possible for the identified object. For example, if there is an indication of explosives, it may be useful to check for different explosive materials as the alarm material. With reference to the preceding paragraph, it should be pointed out here that, for different potential alarm objects within an item of baggage, different alarm materials or combinations of alarm materials can of course also be assigned for these steps of the detection method according to the invention. In addition to alarm materials, a negative test is also conceivable in principle in that non-alarm materials are assigned for this simulation step and the final comparison. In other words, by actively assigning an object to a non-alarm material, the presence of an alarm material can be ruled out depending on the comparison result. A further advantage is achieved in that, in a detection method according to the invention, when carrying out the comparison, a classification method is used, in particular one of the following:

correlation-based classification (in particular, a one-dimensional feature vector),
support vector machines (in particular, a multi-dimensional feature vector),
neural network (in particular, an abstract non-linear (and high-dimensional) feature extraction by convolutional layers and their interpretation by fully-connected layers).

The above listing is a non-exhaustive list. Of course, combinations of the individual classifications are also conceivable.

Correlation-based binary classification describes the classification of substances based on a similarity value (similarity metric). Exceeding a defined threshold value leads to an alarm being generated for the material being sought. Falling below the threshold value leads to no alarm being generated. An example of a similarity value could be the normalised scalar product of the signal with the respective reference.

A support vector machine (SVM) classifies spectra based on several features. These features (e.g. several different similarity metrics) are extracted from the signal to be classified beforehand. The number of features specifies the dimensionality of the “feature space” (a vector space). The SVM now tries to find an optimal hyperplane (maximum distance of the support vectors) in this feature space to separate the objects which would generate an alarm from the objects which would not generate an alarm. The separation by the generated hyperplane can be linear (linear kernel) as well as non-linear (polynomial, radial).

In a CNN (convolutional neural network), manual feature extraction is dispensed with. Instead, weights of a large number of convolution kernels (one-dimensional vectors or matrices) are trained. These convolutions summarise the local environment by means of filters (the convolution). Pooling layers ensure that the filtered data are reduced in that irrelevant information is discarded. The result is a high-dimensional trained non-linear (non-linear using non-linear activation functions: Sigmoid, ReLu, . . . ) feature space (the filters have been trained so that the subsequent classification is as optimal as possible). The features could theoretically be used by SVMs for classification. Usually, however, “fully connected neural networks” are used to interpret the high-dimensional and non-linear feature space and to generate a classification result. The neural network thus consists of two parts, a first part for feature extraction (convolutional neural network) and a second part (fully connected neural network) which separates the high-dimensional feature space. Both parts are trained simultaneously in a learning process.

It may further be advantageous if, in a detection method according to the invention, the comparison yields a similarity value reflecting the similarity between the measurement diffraction result and the simulation diffraction result. This similarity value is in particular an abstract value, which as a single value is simply comparable to a limit value to produce the comparison result. For example, if such a similarity value is high, a low degree of similarity can be assumed, while a low value for a similarity value can indicate a high degree of similarity. Accordingly, a single defined limit value can now be specified for the evaluation and output of the comparison result, from which the degree of similarity is sufficient to affirm a correspondence with the assigned alarm material. The subject matter of the present invention also includes a computer program product comprising commands which, when the program is run on a computer, cause this to carry out the steps of a detection method according to the invention. Thus, a computer program product according to the invention has the same advantages as have been explained in detail with reference to a detection method according to the invention.

### BRIEF DESCRIPTION OF THE FIGURES

Further advantages, features and details of the invention are explained in the following description, in which exemplary embodiments of the invention are described in detail with reference to the drawings. The features mentioned in the claims and in the description may in each case be significant to the invention, individually per se or in any combination. In each case schematically:

FIG. 1 shows a schematic representation of a method according to the prior art,

FIG. 2 shows an embodiment of a detection method according to the invention,

FIG. 3 shows a further embodiment of a detection method according to the invention,

FIG. 4 shows a further embodiment of a detection method according to the invention.

### DETAILED DESCRIPTION

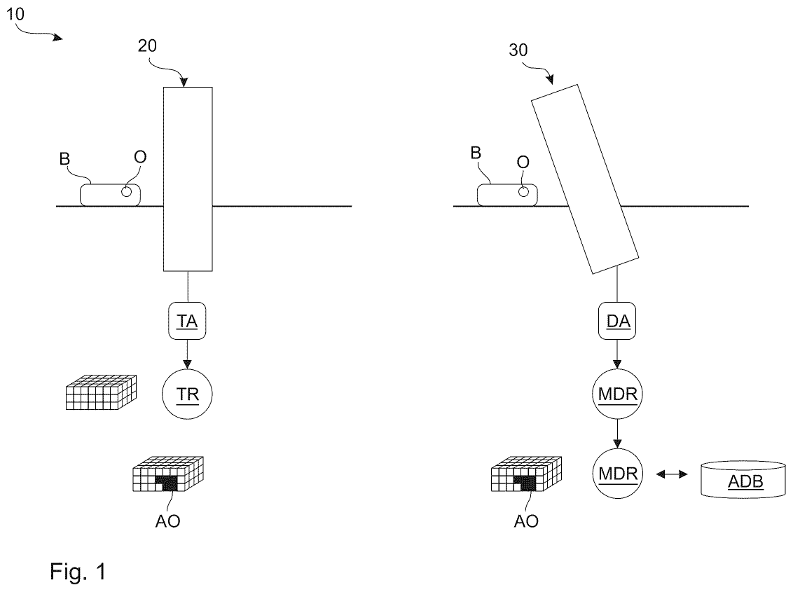

FIG. 1 shows schematically how detection has taken place in the past in a detection system 10, which is in the form here of a System of Systems device. In this case, the detection system 10 is equipped with a transmission device 20, for example a computed tomography scanner. This transmission device 20 performs the transmission analysis TA on the item of baggage B, as a result of which a three-dimensional transmission result TR is obtained. With the help of segmentation, objects O, for example in this case a single object O, can be identified. In the event of an alarm, the item of baggage B can be passed on for further analysis, in this case with the help of a diffraction device 30. This diffraction device 30 is in the form of an X-ray diffraction system so that X-rays diffracted when the item of baggage B is scanned are detected by a corresponding detector, and are output as a result of the diffraction analysis DA and thus as a measurement diffraction result MDS. The measurement detector signal MDS is back-projected into a measurement detector result MDR by reconstruction so that finally a comparison can be made for the potential alarm object AO with an alarm database ADB and idealised comparative values stored therein. As has already been explained, this has disadvantages, since actual measurement errors or impairments of the measurement detector signal MDS and/or the measurement diffraction result MDR are not taken into account in the idealised alarm database ADB.

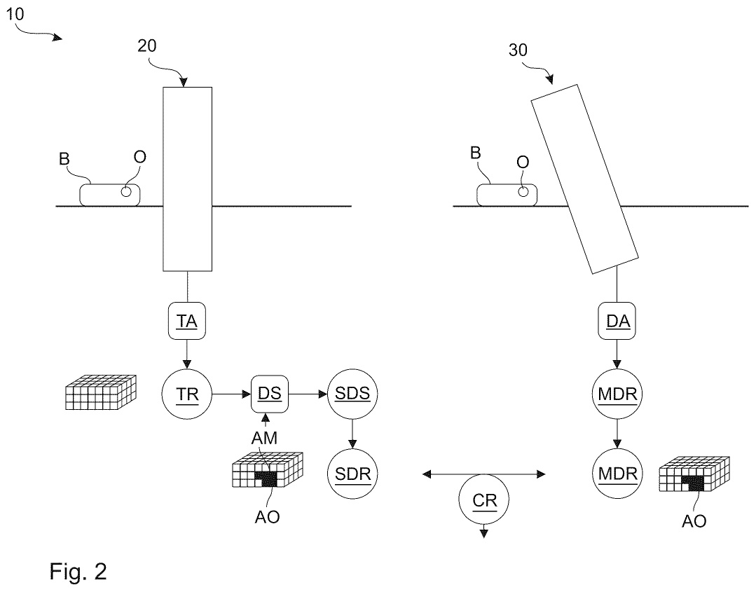

FIG. 2 shows an embodiment of the present invention intended to remedy the aforementioned problems. Here too, a transmission analysis TA is performed with the help of the transmission device 20 so that a three-dimensional transmission result TR can be made available. This is able to identify objects O again by segmentation and in particular to identify potential alarm objects AO by means of a preliminary analysis. For example, in the context of such a preliminary analysis, an indication can also be provided as to a material group for which the identified potential alarm object AO is to be checked in the following step.

In the detection method according to the invention, a simulation detector signal SDS is now generated for the identified potential alarm object AO by means of a diffraction simulation DS. In order to perform this diffraction simulation DS, not only is the subsequent diffraction analysis DA simulated, in addition an alarm material AM is also assumed and assigned to the alarm object AO. This results in a simulation detector signal SDS which can again be reconstructed by back-projection to produce a simulation diffraction result SDR. In other words, this is a simulation section that outputs a prediction and thus a projection of an expected simulation diffraction result SDR for the potential alarm object AO with the assigned alarm material AM.

The diffraction analysis DA is also performed in the known manner so that a measurement detector signal MDS can be detected. The measurement detector signal MDS is also reconstructed again into a measurement diffraction result MDR by means of back-projection, preferably in an identical or substantially identical way to the simulation detector signal SDS. In contrast to the known solutions, as shown for example in FIG. 1, the comparison is not made with an idealised alarm database ADB, but rather between the specific measurement diffraction result MDR for the alarm object AO and the simulation diffraction result SDR specific, and thus individual, to this item of baggage B and this alarm object AO. Accordingly, for the same alarm material AM, the simulation diffraction result SDR will look different for a different alarm object AO and/or a different item of baggage B than for the present case. The simulation diffraction result SDR thus changes for each item of baggage B and each object O so that for each diffraction analysis DA and in the final comparison there is always a simulated simulation diffraction result SDR individualised for this situation. In the final step, the comparison result CR, which in particular indicates whether the alarm object AO has a sufficiently high similarity to the assumed and assigned alarm material AM or not, is output.

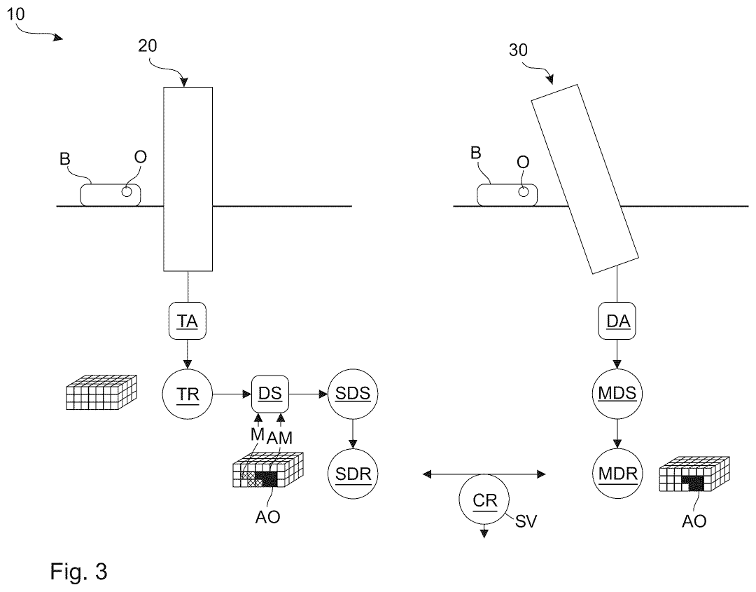

FIG. 3 shows a possible further development of the embodiment of FIG. 2. Here, when considering and applying the diffraction simulation DS, not only is the alarm object AO itself considered, but also adjacent regions next to the alarm object AO. Here, the three-dimensional transmission result TR is represented schematically with individual cube-shaped voxels so that neighbouring voxels next to the alarm object AO can now also be taken into account with the diffraction simulation DS in the simulation and generation of the simulation detector signal SDS. In this case, the adjacent regions next to the alarm object AO are preferably introduced into the diffraction simulation DS with a material M, which is a non-alarm material.

In the embodiment of FIG. 3, the comparison result CR is in addition defined in greater detail. In this case, this is provided with a similarity value SV which in particular has a scalar form. Such a similarity value can be a simple parameter that can be compared with a limit value to indicate the degree of similarity and thus easily distinguish whether the alarm object AO has a similarity to the assigned alarm material AM or not.

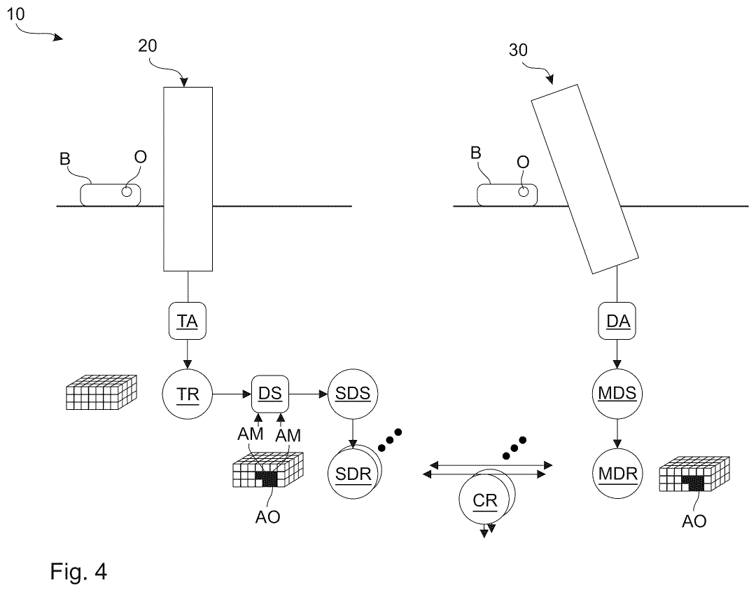

FIG. 4 also shows several possibilities for further development of a detection method according to the invention. On the one hand, it can clearly be seen here how the diffraction simulation DS is not carried out only once for this alarm object AO. Rather, for example different alarm materials AM are assigned here so that the diffraction simulation DS is also carried out multiple times. This results in two different simulation detector signals SDS and accordingly also two different simulation diffraction results SDR. In the end result, the one measurement diffraction result MDR is now compared several times with different simulation diffraction results SDR so that different comparison results CR specific for each alarm material AM are obtained. In this way, a potential alarm object AO can be checked for different alarm materials AM with the same effort since the diffraction analysis DA only has to be carried out once and the corresponding checking situation is integrated into the multiple application of the diffraction simulation DS.

The above explanation of the embodiments describes the present invention exclusively in the context of examples. Individual features of the embodiments can, where technically expedient, be freely combined with each other without departing from the scope of the present invention.

### LIST OF REFERENCE SIGNS

10 detection system
20 transmission device
30 diffraction device
TA transmission analysis
TR transmission result
DA diffraction analysis
MDR measurement diffraction result
SDR simulation diffraction result
CR comparison result
SV similarity value
DS diffraction simulation
SDS simulation detector signal
MDS measurement detector signal
M material
AM alarm material
O object
AO alarm object
B item of baggage
ADB alarm database

1. A detection method for detecting alarm objects in items of baggage, the method comprising the following steps:
performing a transmission analysis on an item of baggage to generate a transmission result,
segmenting the transmission result to identify objects,
generating a simulated simulation detector signal for at least one identified object,
assigning an alarm material by means of a diffraction simulation specific to a diffraction analysis,
performing the diffraction analysis on the item of baggage to generate a measurement detector signal,
reconstructing a measurement diffraction result from the generated measurement detector signal for the at least one object,
reconstructing a simulation diffraction result with the same dimensionality as the measurement diffraction result based on the generated simulation detector signal for the at least one object,
comparing the measurement diffraction result with the simulation diffraction result, and
outputting a comparison result.

2. The detection method according to claim 1, wherein a corresponding simulated simulation detector signal is additionally generated for adjacent regions in addition to the at least one identified object with a respective assigned material.

3. The detection method according to claim 1, wherein a preliminary analysis is performed for the at least one identified object, with regard to at least one of the following parameters:
form of the at least one identified object, or
density of the at least one identified object.

4. The detection method according to claim 3, wherein the further analysis is carried out depending on the result of the preliminary analysis.

5. The detection method according to claim 1, wherein the diffraction simulation takes into account at least one of the following parameters:
angular resolution of the diffraction analysis to be performed,
spatial resolution of the diffraction analysis to be performed, which can lead to signal mixing,
attenuation of the scattering signal of the diffraction analysis to be performed by further objects in the item of baggage and thus the expected distribution of the variance of the noise over the momentum transfer axis, or
attenuation of the detector response during the diffraction analysis to be performed.

6. The detection method according to claim 1, wherein a back-projection or reconstruction is carried out to generate at least one of the measurement diffraction result or the simulation diffraction result.

7. The detection method according to claim 1, wherein the step of segmenting the transmission result is carried out based on homogeneous volumes.

8. The detection method according to claim 1, wherein the steps are carried out for at least two different identified objects in the item of baggage.

9. The detection method according to wherein, for the at least one identified object, at least two different alarm materials are assigned for the generation of at least two corresponding simulated simulation detector signals

10. The detection method according to one of the wherein, during said comparing, a classification method is used, the classification method including one of the following:
correlation-based classification,
support vector machines, or
a neural network.

11. The detection method according to claim 1, wherein said comparing yields a similarity value reflecting the similarity between the measurement diffraction result and the simulation diffraction result.

12. A non-transitory computer program product comprising computer-executable instructions which, when the program is executed by at least one processor of a computer, cause the at least one processor to carry out the steps of claim 1.
